(19) United States
(12) Patent Application Publication
(10) Pub. No.: US 2002/0126962 A1
(43) Pub. Date: Sep. 12, 2002

(54) BRENT WAVEGUIDE FOR CONNECTION TO AT LEAST ONE DEVICE, ADAPTIVE PASSIVE ALIGNMENT FEATURES FACILITATING THE CONNECTION AND ASSOCIATED METHODS

(76) Inventors: MICHAEL AARON KADAR-KALLEN, HARRISBURG, PA (US); JOH ROBERT ROWLETTE SR., HUMMELSTOWN, PA (US); ERIC GREEN, HARRISBURG, PA (US)

Correspondence Address: WILLIAM S. FRANCOS, THE WHITAKER CORPORATION, 4550 NEW LINDEN HILL ROAD, SUITE 450, WILMINGTON, DE, 198082952

(21) Appl. No.: 09/215,442

(22) Filed: Dec. 18, 1998

Related U.S. Application Data
(60) Provisional application No. 60/068,100, filed on Dec. 19, 1997.

(51) Int. Cl. G02B 6/36

(52) U.S. Cl. 385/88

(57) ABSTRACT

A bent, flexible optical waveguide is attached to a device which receives or transmits optical signals. The bend of the flexible waveguide allows the relative positioning of the device to be in a different plane than an opposite end of the waveguide and is robust under a variety of environmental stresses. When used with two or more devices, e.g., a transceiver having both a transmitter array and a receiver array, the bend of the flexible waveguide allows the separate ends of the waveguide to be adaptively aligned independently. An alignment feature created adjacent to the device in accordance with the position of the device is used to passively align the tips of the waveguide to the module. The alignment feature can be of any shape that allows them to abut and hold the end of the waveguide, including cylinders, cutout regions of a transparent layer, and slots in or between the pedestals. The optical waveguide bends the direction of the light propagating within the waveguide to allow communication between the device and a component attached to the opposite end of the waveguide.

### CROSS-REFERENCE TO RELATED APPLICATIONS

This application claims priority under 35 U.S.C. §119 to Provisional Application Serial No. 60/068,100 filed Dec. 19, 1997, which is hereby incorporated by reference in its entirety for all purposes.

### BACKGROUND OF THE INVENTION

1. Field of the Invention

The present application is directed to using a bent waveguide to connect to at least one device for transmitting or receiving optical signals, especially when constructing connectorized transceiver modules. The bend of the flexible waveguide allows the relative positioning of the device to be in a different plane than an opposite end of the waveguide and is robust under a variety of environmental stresses. In particular, a flexible waveguide having separate arms is used to connect two or more devices, e.g., a laser transmitter array and a receiver detector array, typically to a connector. The separate arms allow the ends of the waveguide to be adaptively, passively aligned independently.

2. Description of Related Art

Transceivers are devices which electrically or optically communicate with other devices. A transceiver consists of one or more transmit channels used to send information to other devices, and one or more receive channels used to receive information from other devices. Optical transceivers transmit and receive optical signals via optical fibers or waveguides which are typically terminated with connectors. Often the transmitter and receiver chips emit and receive light in a direction which is substantially perpendicular to the direction of the mating connector for the transceiver. It is then necessary to provide a means for changing the propagation direction of the light by 90 degrees.

The use of bulk optics, such as mirrors and lenses, is one solution to this problem. However, vibration and temperature changes can alter the alignment between the transmitter, receiver, connector, and bulk optics. Additionally, any inconsistencies in positioning arising during the manufacturing and integration process can result in misalignment of the optical path. Either of these sources of misalignment will render the transceiver ineffective.

An alternative to bulk optics is the use of optical waveguides. Such waveguides are typically terminated with a 45 degree mirror to couple light from the transmit and receive chips into the waveguides. The waveguides are then directly mated to the connector. Such a solution is effective for systems incorporating a single transmit chip or a single receive chip, but is not effective if independent transmit and receive chips are present in a transceiver module. In such cases, two waveguides may be used, one for the transmit chip and one for the receive chip. Unfortunately, this increases the cost and size of the transceiver module, since two separate ferrules are required.

In either of these configurations, the use of a mirror results in a loss of optical power. As an alternative to bending the light, others have manufactured the electronics to incorporate a bend, so that the light emitted from the transmit and receive arrays are substantially in the same direction as the connector. This simplifies the optical design, but adds complexity to the electronic design and forces design tradeoffs that may adversely affect the performance of the electronics, particularly at high data rates.

### SUMMARY OF THE INVENTION

The concepts of the present application overcome substantial disadvantages of the conventional connection to devices for transmitting and/or receiving optical signals. It is an object of the invention to make the optical connections more reliable, increase design flexibility, reduce the possibility of physical damage, reduce cost during integration and/or operation, and/or provide a more reliable connection between the transceiver and waveguide.

It is yet another object of the present invention to provide an optical connector which can be adaptively and independently aligned to two or more devices.

At least one of these and other objects of the invention can be realized by attaching a bent waveguide to a device for transmitting and/or receiving optical signals. Because the waveguide is bent, a portion of the waveguide extends into a plane different from a plane of the device. The device may include a vertical cavity surface emitting laser (VCSEL) array or an array of photodetectors.

In another embodiment of the present invention, an alignment feature is attached adjacent to the device to accept an end of the waveguide. The alignment feature has an edge extending along the periphery of the device. Then, the end of the waveguide is passively aligned with the device by positioning the waveguide with the alignment feature. Two schemes are described for achieving this passive alignment, as opposed to active alignment which requires the active elements be turned on.

In a “chips first” approach, the device is positioned on a structure at an early point of the assembly, such that the final structure, e.g., an MCM, has a flat, featureless surface. Any mechanical alignment features added to the device itself are removed or obscured during the creation of the structure, while visual alignment features remain. Raised mechanical features can be created on the surface of the structure by removably attaching a layer to the structure, determining the position of the transmitter and receiver arrays, laser micromachining a pattern in the layer, and removing the layer from the structure to leave the alignment features. Assembly of the waveguide to the structure consists of placing the end of the waveguide against the mechanical alignment features, and bonding the waveguide to the structure.

In a “chips last approach”, the device is added to the structure near the end of the assembly process, such that any mechanical alignment features on the chips will be accessible during assembly of the waveguide to the structure. The mechanical alignment features are best added to the device at a wafer level, where the adaptive alignment only needs to be performed once. Such features may be produced by patterning photoresist features, or using the manner noted in the “chips first” approach. As in the chips first approach, assembly of the waveguide to the structure consists of placing the end of the waveguide against the mechanical alignment features, and bonding the waveguide to the structure.

When used with two or more devices, the bent waveguide preferably includes independently aligned arms. When the two or more devices, e.g., a transmitter and a receiver, are combined, the relative locations of these devices are not exactly known. Therefore, when a waveguide is used to propagate the light to or from the devices, all of the ends of the waveguide to be attached to a respective device must be aligned independently. The waveguide may combine both the transmitted and received signals into a single connector, e.g., a ferrule. Alignment features may be provided for each device to which an end of the waveguide is to be attached in either manner described above.

When used with only two devices, the waveguide is preferably “Y” shaped and has three arms. The first and second arms are independently aligned to the two devices, e.g., a transmitter and a receiver, and the third arm may connect to a ferrule. Because the waveguide is bent, the plane of the connecting portions of the first and second arms is different from the plane of the portion that aligns the third arm to the communication connector or ferrule. The bend in the waveguide alters the direction of the light as it propagates along the waveguide.

At least one of these and other objects can be realized by providing an adaptive passive alignment method for attaching a bent waveguide to a device for receiving or transmitting optical signals including attaching an alignment feature adjacent the device, the alignment feature having an edge extending to the device and passively aligning an end of the bent waveguide with the device by placing the waveguide in contact with the alignment feature. The alignment feature may be made in either manner set forth above.

At least one of these and other objects of the present invention can be realized by providing a method of creating alignment features on a module including visually inspecting the module to identify positions of portions on the module to be aligned with and creating alignment features on the module in accordance with the positions. Again, the alignment features may be made in either manner set forth above.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and in the accompanying drawings which are given by way of illustration only and thus are not limitative of the present invention and wherein:

FIG. 1 illustrates a waveguide assembly before first and second arms of the waveguide are aligned in the alignment pedestals attached to the MCM in accordance with a preferred embodiment of the invention;

FIG. 2 illustrates the waveguide assembly of FIG. 1 having one arm of the waveguide aligned in the alignment pedestals;

FIG. 3 illustrates the waveguide assembly of FIG. 1 having two arms of the waveguide aligned in the alignment pedestals;

FIG. 4 illustrates a top surface of an overmold of the transmitter and receiver arrays, hereinafter referred to as a multi-chip module (MCM), in accordance with another preferred embodiment of the present application;

FIG. 5 illustrates the MCM of FIG. 4 partially covered with a transparent polymer material;

FIG. 6 illustrates the MCM and polymer layer of FIG. 5 with slots carved around the arrays;

FIG. 7 illustrates the MCM and cut polymer layer of FIG. 6 with the carved section of the polymer layer removed;

FIG. 8 illustrates a waveguide and ferrule having one arm of the waveguide in aligned connection with the MCM and polymer layer of FIG. 7;

FIG. 9 illustrates an MCM according to another preferred embodiment of the present application;

FIG. 10 illustrates a transparent layer over the MCM of FIG. 9;

FIG. 11 illustrates the MCM and transparent layer of FIG. 10 with cylinders cut into the transparent layer;

FIG. 12 illustrates the MCM and transparent layer of FIG. 11 with the transparent layer removed except for the cylindrical pedestals carved from the transparent layer;

FIG. 13 illustrates a ferrule and waveguide connected to the MCM and pedestals of FIG. 12;

FIG. 14 illustrates alignment blocks abutting the waveguide arms of the transceiver apparatus shown in FIG. 13;

FIG. 15 is a schematic top view of a transceiver apparatus in accordance with yet another embodiment of the present application;

FIG. 16 illustrates a transceiver apparatus incorporated into a communication device; and

FIG. 17 illustrates a side view of the transceiver apparatus of FIG. 16.

### DETAILED DISCUSSION OF THE PREFERRED EMBODIMENTS

The exemplary embodiments of the invention claimed and the appended claims may be more fully appreciated by reference to the following description of preferred embodiments. Within the drawing figures, it should be understood that like elements are identified by like reference numbers.

As an example of a configuration in accordance with the present invention, a flexible optical waveguide having at least three arms to connect both transmitter and receiver signals, e.g., to a single connector, such as a ferrule, will be described below. Arms other than that to the connector must be independently aligned and connected to both arrays.

The two arms to the transceiver are bent out of the plane of the connector and/or of the devices. This bend gives these individual arms the flexibility needed to independently align the two arms, one to the transmitter (Tx) array and one to the receiver (Rx) array. This bend also eliminates the need for a mirror to supply light from the Tx array into the waveguides, and from the waveguides into the Rx array detectors. The source of light for the Tx channels may be, for example, an array of VCSELs. The light which is received by the transceiver may be directed to, for example, a 12-channel detector array.

The detailed description discloses several approaches for aligning and connecting the waveguides to the arrays. Although each embodiment is described for either a “chips last” or “chips first” approach, the structure and process for connecting the waveguide to the arrays are applicable for either approach.

Because the alignment features are created to facilitate subsequent alignment, several devices that need waveguides aligned to them can be placed on one carrier and cut for the several devices using laser micromachining. The devices can then be removed from the laser micromachining workstation and transferred to a less expensive station where the bonding can take place. Therefore, the bonding does not tie up the equipment used for achieving precision alignment, and thereby reduces the cost of assembly.

One approach for independently aligning the waveguide to the arrays is illustrated in FIGS. 1-3. This approach is called a “chips last” approach. FIGS. 1-3 all show a waveguide assembly 1 including a bent “Y” shaped waveguide 10 having arms 12, 14 that connect with the Tx and Rx arrays 13, 15, respectively and a third arm 16 that connects a connector or ferrule 22.

In a “chips last” approach, Rx and Tx chips 13, 15 are placed in a wafer (not shown) such that the surfaces of the chips are directly accessible. The wafer is patterned with alignment pedestals 18, 20 over the arrays based on visual inspection. The alignment pedestals 18, 20 have openings for receiving and aligning waveguide arms 12 and 14. Any opening that has a surface to receive and align the arms 12 and 14 may be used, including slots. The alignment pedestals 18, 20 may have any pattern appropriate for securing an end of a waveguide therein.

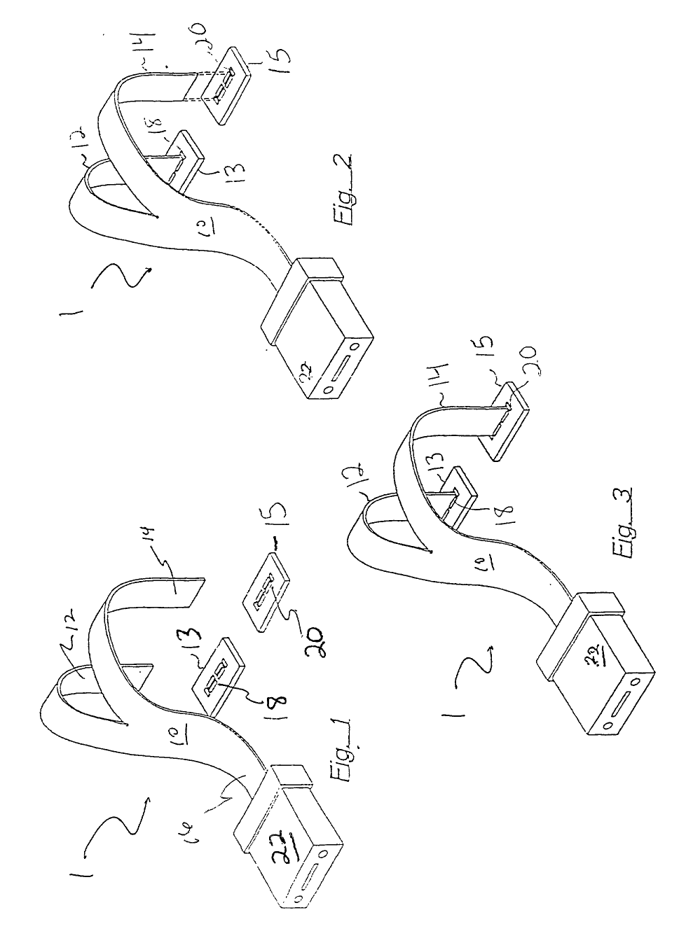

FIG. 1 illustrates the waveguide assembly 1 before arms 12 and 14 are aligned with the chips 13, 15 covered by the alignment pedestals 18 and 20. FIG. 2 illustrates the waveguide assembly 1 having the arm 12 aligned in the alignment pedestal 18. FIG. 3 shows the waveguide assembly 1 with arms 12 and 14 aligned and connected to the Tx and Rx chips via alignment pedestals and 20. Thus, the transceiver is connected to the ferrule 22.

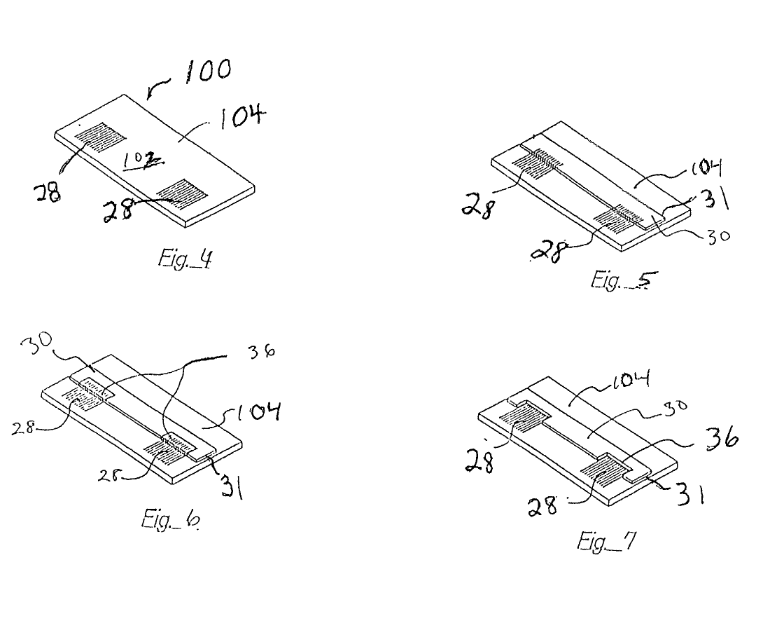

A second embodiment of the present application is disclosed in FIGS. 4-8. This embodiment incorporates a “chips first” approach for aligning the waveguide assembly 1 to the Tx and Rx arrays. Several chips, such as Tx and Rx chips are combined within a plastic housing 102 to make a structure, e.g., multichip module (MCM) 100. After the chips are overmolded with the plastic housing 102, a top surface 104 where the waveguide 10 must attach is very flat and there are no mechanical features for aligning the waveguides. FIG. 4 shows an example of multichip module 100 having the top surface 104 which embeds the Tx and Rx array chips. The physical location of the chips 13, 15 within the module can be visibly determined through the top surface 104 of the transparent plastic housing 102 and are indicated at locations 28.

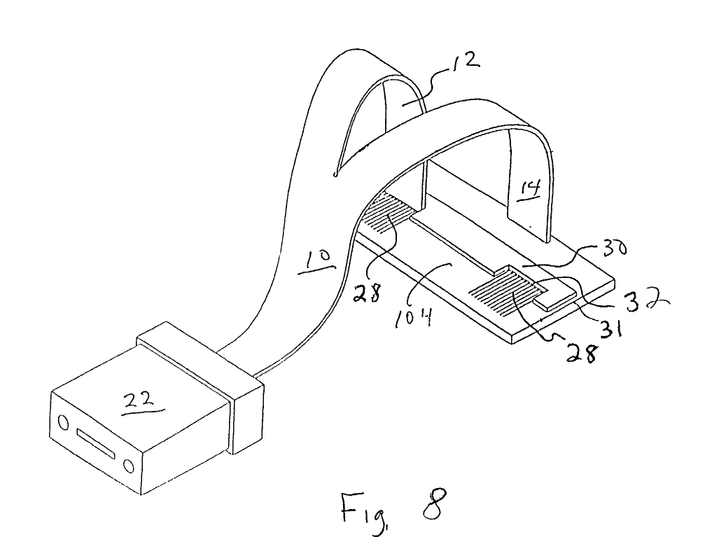

In FIG. 5, a transparent polymer layer 30 is placed over the MCM 100 and bonded to the surface 104 using an adhesive layer 31. The layer 30 is preferably thin, e.g., 250 microns, thick. Then the location 28 of the arrays are determined visually and an outline of slots 36, as shown in FIG. 6, is cut around the arrays to form an abutting edge for the waveguide arms 12 and 14. These cuts are made in regions which avoid electrical connections to the arrays.

In FIG. 7, the portions of the layer 30 which have been outlined are removed, leaving alignment indentations or slots 36 which are used during assembly. This procedure is known as an “adaptive” alignment, since the location of the laser cuts are adapted to the location of the arrays. If a polymer, e.g., a polycarbonate or acrylate, is used as the layer 30 and attached to the surface 101 using an appropriate polymer adhesive as the layer 31, the unwanted portions which have been outlined may be simply pulled off. FIG. 8 shows a waveguide assembly having the first arm 12 aligned with one of the arrays.

Accordingly, the “chips first” approach can be used to create slots 36 on the surface of a multichip module 100. The slots serve as alignment features and are created at locations which are accurately determined in reference to the Tx and/or Rx arrays which are embedded in the MCM material.

Features other than the specific slots or pedestals shown in the preceding Figures can be created and used for passive alignment. For example, a cylindrical shaped pedestal can be quickly cut in the thin material which is placed on the MCM and is independent of the angle of the arrays with respect to a laser micromachining workstation. This simplifies the translation of the laser cut geometry and thus provides the benefit of less costly manufacture. Creation of cylindrical pedestals as alignment features using the “chips first” approach is shown in FIGS. 9-15.

Again, as with FIGS. 4-8, both the transmitter and receiver arrays are packaged in the MCM 100 that embeds the arrays in a transparent housing, such as a plastic housing 102. The finished module is flat on top with the transmitter and receiver arrays both visible through the transparent plastic housing 102 as shown in FIG. 9.

In FIG. 10, again a layer of transparent material (such as a polycarbonate or acrylate) is bonded to the top surface of the MCM 100 using an adhesive which makes a nonpermanent bond to the top surface 104 of the MCM 100. The adhesive layer 31 should be relatively transparent so that the VCSELs and detectors can be visually inspected through the transparent material and adhesive in order to align the laser micromachining cuts. It may be beneficial to allow time for the adhesive layer 31 to sufficiently bond to the MCM 100 before the micromachining step.

The position of the VCSEL and detector arrays 28 is determined using a vision system. FIG. 11 illustrates circles 32 (typically 1 mm in diameter with a 10 ·m line width) cut with respect to these arrays. The circles can be formed using laser micromachining cuts.

FIG. 12 shows the pedestals 32 left behind after the transparent material 30 has been removed from the MCM 100. When the transparent material 30 is a polymer and is bonded with an adhesive as layer 31, the layer 30 can be removed by placing, for example, a razor blade under the transparent layer 30 and lifting the edge of the layer 30 slowly until it “pops” off. The pedestals should remain in place, as shown in FIG. 12. However, if any pedestal 32 is removed with the transparent layer 30, then the other pedestals 32 can be removed and the adhesive process rerun.

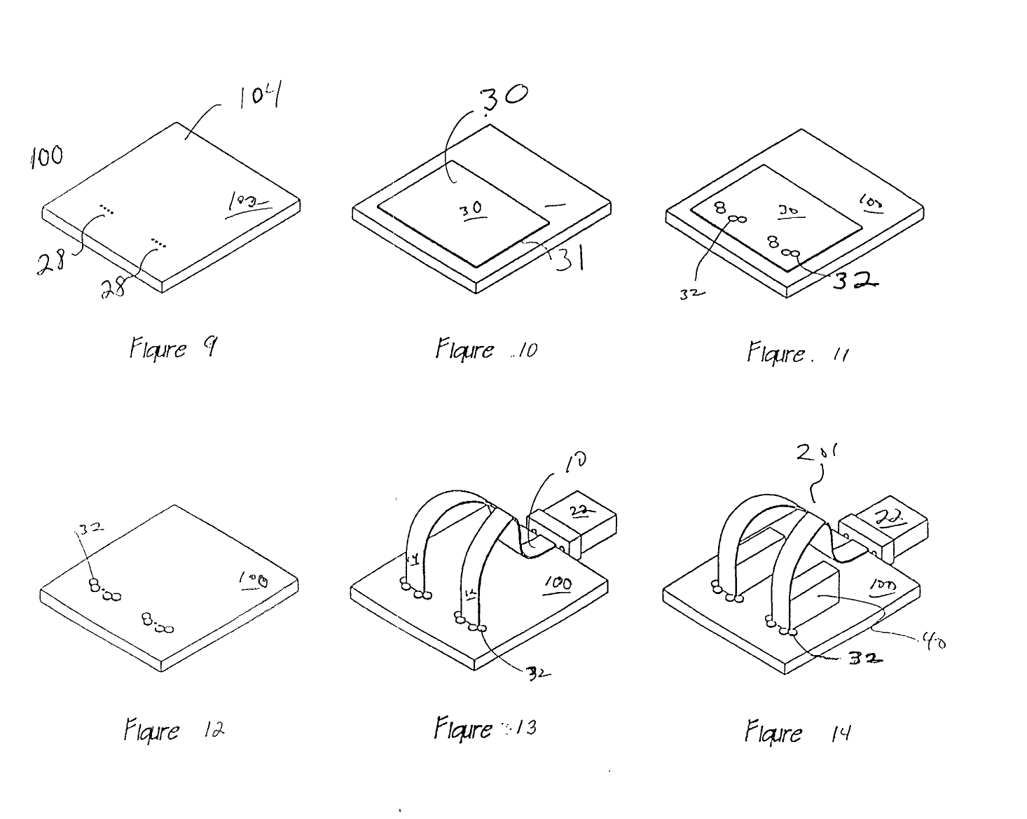

In FIG. 13, waveguide arms 12 and 14 are brought roughly into place against the pedestals 32 and MCM 100. The waveguide arms 12 and 14 should be placed as close as possible to the pedestals and at most a small distance from the MCM surface as necessary to allow the waveguide arms 12, 14 to be properly aligned with the pedestals.

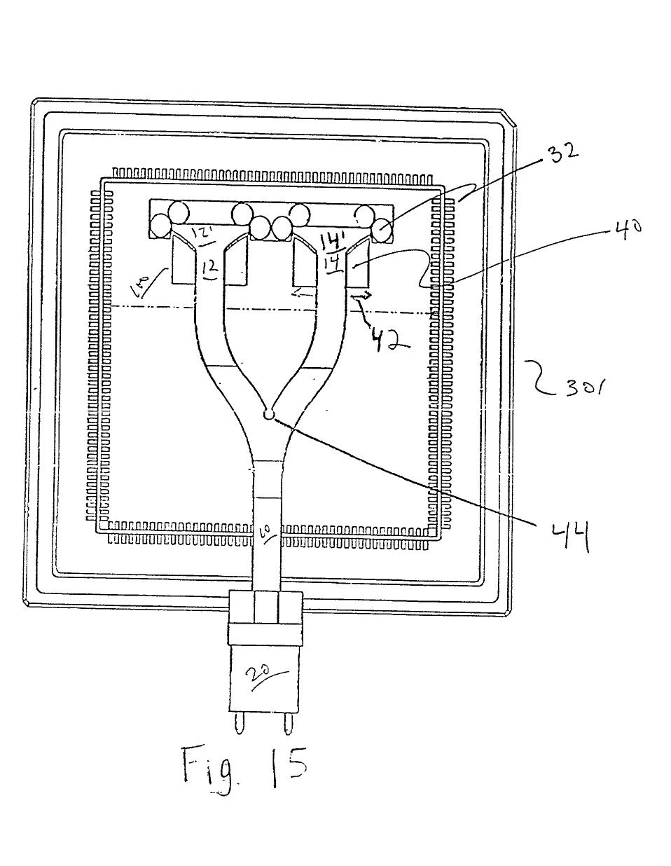

In FIG. 14, fused silica blocks 40 are used to push the waveguide against the pedestals 32, thereby aligning the waveguide 10 to the VCSEL and detector arrays.

Fused silica blocks 40 are inexpensive and allow UV light to be transmitted to a UV-curable adhesive used to bond the waveguide to the MCM. The fused silica blocks may be used with any of the other alignment feature configurations. The blocks 40 provide support for the waveguide 40 while it is bonded to the MCM 100. Contact between the waveguide and top pedestals can be verified by pushing the waveguide 10 away from the pedestals 32 and observing the waveguide 10 return into contact with the pedestals 32. Contact with all four pedestals can be verified by observing this motion, for example, with a stereo microscope.

The pedestals 32 are created to facilitate alignment which is done at a later time. If several devices all need waveguides 10 aligned to them, all the devices can be positioned on one carrier and the pedestals 32 cut for the several devices. The devices can then be removed from the laser micromachining workstation and transferred to a less expensive station where the bonding can take place. Therefore, the bonding does not tie up the equipment used for achieving precise alignment and, thereby reduces the cost of assembly.

This embodiment uses cylindrically shaped pedestals because the pedestals 32 can be quickly cut in the thin transparent layer 30 and the pedestals 32 create reliable point contact. The shape of the pedestals 32 is independent of the angle of the VCSEL or detector arrays with respect to the servo table of the laser micromachining workstation. This simplifies the translation of the laser cut geometry.

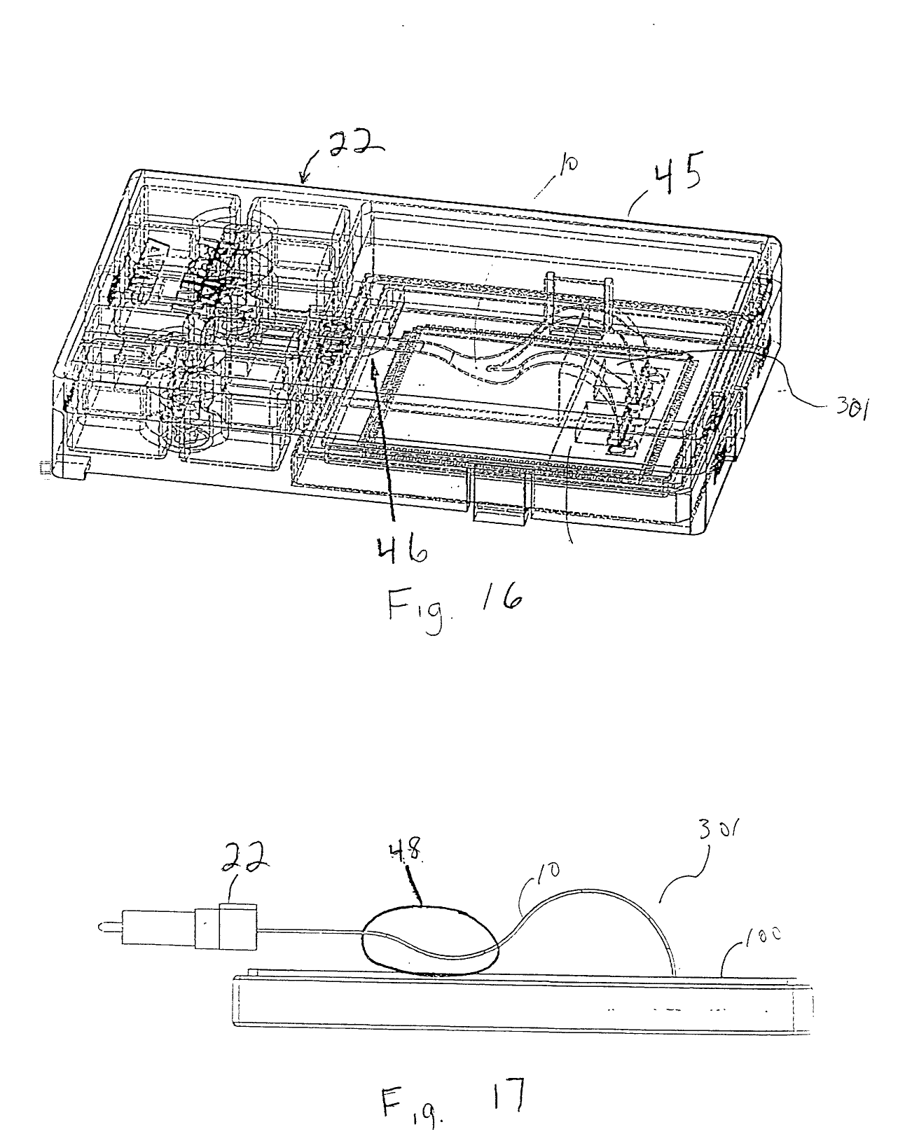

FIG. 15 is another configuration of the waveguide assembly 1 and alignment features. The fused silica blocks 40 have a wider cross-section.42 than previously shown. This wider cross-section 42 allows the pedestals to be moved further away from the chip region to prevent any damage that may have occurred during the pedestal cutting steps. This wider cross-section 42 also provides a large bonding surface to both the waveguide 10 and the MCM 100.

The waveguide arms 12, 14 in FIG. 15 have flared ends 12′, 14′, respectively. The resulting transitional geometry from the narrower section of the arms, for example, 2600 μm to the wider section 12′, 14′ of the arms, for example 7500 μm, decreases the flexibility of the waveguide arms 12 and 14 to shift the waveguide deflection away from the pedestals 32 and fused silica blocks 40 resulting in a more uniformly curved waveguide 10. Further, the bonding surface of the waveguide 10 maintains a large bonding surface with the fused silica block 40 which secures the waveguide 10 to the MCM 100.

The waveguide 10 also includes a stress limiting notch 44 in the fork of the waveguide 10. This notch prevents propagation of a potential tear or the formation of a tear during flexing of the waveguide 10.

FIG. 16 illustrates a bend limiting feature 46 inside the transceiver housing cover 45 that prevents the waveguide 10 from having an unacceptably small bend radius as it extends from the connector 22 and thus minimizes optical loss. FIG. 17 illustrates a small additional service length of the waveguide 10 at 48. The additional length 48 is desirable to allow the waveguide 10 to deflect as the connector 22 is guided into place when the transceiver is assembled. The additional length 48 also permits the waveguide 10 to tolerate translation and thermal expansion and contraction.

While numerous variations have been described with reference to the “chips first” approach, the “chips last” approach, in which the surfaces of the VCSEL and detector chips are accessible, may also incorporate these variations. For example, features similar to the pedestals described above can be patterned on a surface of the arrays. The waveguide 10 can then be pushed against these pedestals using the blocks and bonded as described above. A landing surface may have to be added to the MCM 100 to provide a flat surface to bond the fused silica block 40 to the MCM 100. Thus, these are further variations on how alignment may be achieved using the “chips last” approach.

In the preferred embodiments of the present application, alignment features are created by adaptively laser micromachining circles from a piece of transparent material which is placed over a transmitter or receiver array. The alignment features are then used to passively align the waveguide to the transmitter and receiver arrays.

Although the embodiment described above will use this technique, the following features of the invention may be more generally applied.

The alignment features are created after visually determining the position of the arrays. The passive alignment technique is therefore adaptive. This is particularly well suited to applications where the position of the arrays is not known with a high enough precision to allow other passive alignment techniques to be used.

Passive alignment is achieved by pressing the element to be aligned, for example, the waveguide, against the alignment features which are created. Devices other than waveguides can be aligned using this technique. For example, alignment features of about 700 ·m in diameter spaced by 4.6 mm have been created and used to align a ferrule which has holes or pins of this diameter and spacing.

While the use of a bent waveguide has been discussed above specifically for use with a connecterized transceiver constructed using MCMs, the same waveguide alignment techniques could be used with other applications. For example, these techniques could be used with only transmitters or only receivers. The techniques could also be applied to so-called pigtailed devices, i.e., devices which do not have a connector, but just a bare waveguide at the output. Finally, the “chips last” approach could be applied to chip-on-board or chip-on -flex circuits which have chips that are accessible and electrically interconnected.

Additionally, while the above discussion has focused on the use of a flexible waveguide with two devices which can either transmit or receive optical signals, the flexible waveguide can be used with a single device or with more than two devices. When used with a single device, the ability to independently align arms is no longer needed, since there is only a single arm, but the use of the bent waveguide still provides flexibility as to the relative placement of the device and is robust under a range of environmental stresses.

It should be apparent from the aforementioned description and attached drawings that the concept of the present application may be readily applied to a variety of preferred embodiments including those described herein. Accordingly, the scope of the invention described in the instant application should be limited solely by the appended claims.

What is claimed is:

1. An apparatus comprising:
a device for at least one of transmitting and receiving optical signals; and
a bent waveguide having a portion thereof extending into a plane different from a plane of the device, the bent waveguide being attached to the device.

2. The apparatus of claim 1, wherein the device includes a vertical cavity surface emitting laser array.

3. The apparatus of claim 1, wherein the device includes an array of photodetectors.

4. The apparatus of claim 1, further comprising alignment features adjacent to the device for positioning the bent waveguide relative to the device.

5. The apparatus of claim 4, wherein the alignment features are pedestals having a thickness of about 250 ·m.

6. The apparatus of claim 1, further comprising an attachment layer attached adjacent the device, the attachment layer having a first edge outlined around the device for adaptive, passive alignment of the waveguide to the device.

7. The transceiver module of claim 1, wherein the alignment features include pedestal units that remain fixed to the multichip module and outlined around the transmitter and receiver for alignment with the bent waveguide.

8. The apparatus of claim 4, further comprising an attachment block which urges the waveguide to align the waveguide to the device.

9. The apparatus of claim 8, wherein the waveguide and the attachment block are bonded together.

10. The apparatus of claim 6, wherein the attachment layer is substantially transparent.

11. The apparatus of claim 4, wherein the alignment features include cylindrical pedestals.

12. The apparatus of claim 1, wherein an end of the waveguide being attached to the device has a flared alignment end.

13. The apparatus of claim 1, wherein the waveguide has a bend limiting alignment end that is less flexible than other portions of the waveguide.

14. The apparatus of claim 1, wherein the waveguide has a length sufficient for deflection and thermal expansion or contraction of the waveguide.

15. The apparatus of claim 1, further comprising another device for at least one of receiving and transmitting optical signals, wherein the waveguide has a first arm and a second arm independently aligned to the device and the another device, and has a third arm extending in a plane different from a plane of alignment of the first and second arms.

16. The apparatus of claim 15, wherein an extending end of the third arm has a bend limiting portion that maintains a sufficiently large bending radius to minimize optical loss.

17. The apparatus of claim 15, further comprising a stress limiting notch at the intersection of the first and second arms that prevents the formation of a tear during flexing of the waveguide.

18. The apparatus of claim 15, further comprising first alignment features adjacent to the device and second alignment features adjacent to the another device for respectively positioning first and second arms of the waveguide.

19. An adaptive passive alignment method for attaching a bent waveguide to a device for at least one of receiving and transmitting optical signals, the method comprising:
attaching an alignment feature adjacent the device, the alignment feature having an edge extending to the device; and
passively aligning an end of the bent waveguide with the device by placing the waveguide in contact with the alignment feature.

20. The method of claim 19, wherein said attaching includes:
removably attaching a thin layer adjacent to the device;
determining a position of the device;
creating pedestals in the thin layer; and
removing the thin layer surrounding the pedestals, the pedestals serving as the alignment feature.

21. The method of claim 19, wherein said attaching includes:
removably attaching a thin layer adjacent to the device;
determining a position of the device; and
removing a portion of the thin layer to expose edges outlined around the device, an area remaining after said removing serving as the alignment feature.

22. The method of claim 19, further comprising urging attachment blocks against the waveguide to abut the waveguide with the alignment feature.

23. The method of claim 22, further comprising bonding the waveguide and attachment blocks together.

24. A method of creating alignment features on a module comprising:
visually inspecting the module to identify positions of portions on the module to be aligned with; and
creating alignment features on the module in accordance with the positions.

25. The method of claim 24, wherein said creating includes:
removably attaching a thin layer to the module;
creating pedestals in the thin layer in accordance with the positions; and
removing the thin layer surrounding the pedestals from the multichip module, the pedestals serving as the alignment features.

26. The method of claim 24, wherein said attaching includes:
removably attaching a thin layer to the multichip module; and
removing a portion of the thin layer to expose edges outlined around the portions, an area remaining after said removing serving as alignment features.
